(19) United States
(12) Patent Application Publication
(10) Pub. No.: US 2024/0304989 A1
(43) Pub. Date: Sep. 12, 2024

(54) SIW INCLUDING GLASS SUBSTRATE AND EPA INCLUDING THE SAME

(71) Applicants: CORNING INCORPORATED, Corning, NY (US); INCHEON UNIVERSITY INDUSTRY ACADEMIC COOPERATION FOUNDATION, Incheon (KR)

(72) Inventors: Sungtek Kahng, Seoul (KR); Byounggwan Kang, Seoul (KR); Chang-hyeong Lee, Hwaseong-si (KR); Gwanggyun Namgung, Incheon (KR)

(21) Appl. No.: 18/270,404

(22) PCT Filed: Dec. 14, 2021
(86) PCT No.: PCT/US2021/063212

§ 371 Date: Jun. 29, 2023

(30) Foreign Application Priority Data
Dec. 30, 2020 (KR) 10-2020-0188533

(51) Int. Cl. H01Q 3/36; H01P 1/18; H01P 3/12; H01Q 21/29

(52) U.S. Cl. CPC H01Q 3/36; H01P 1/182; H01P 3/121; H01Q 21/29

(57) ABSTRACT

Provided is an electromagnetic phased array (EPA) including an signal distributor comprising an input port to which a signal is input and first to fourth output ports from which the signal is divided and output, first to fourth waveguides sequentially connected to the first to fourth output ports and having different lengths, and first to fourth antennas sequentially connected to the first to fourth waveguides, in which the signal distributor and the first to fourth phase shifters comprise a substrate integrated waveguide (SIW) based on a glass substrate.

### CROSS-REFERENCE TO RELATED APPLICATION

This application is based on and claims priority under 35 U.S.C. § 119 to Korean Patent Application No. 10-2020-0188533, filed on Dec. 30, 2020, in the Korean Intellectual Property Office, the disclosure of which is incorporated by reference herein in its entirety.

### BACKGROUND

### 1. Field

The inventive concept relates to a substrate integrated waveguide (SIW) and an electromagnetic phased array (EPA) including the SIW, and more particularly, to an SIW including a glass substrate and an EPA including the SIW and suitable for high frequency band communication.

### 2. Description of Related Art

In a wireless network service, a new generation of service has introduced new features to customers and the industry. In detail, a mobile phone service and a text message were introduced in the 1^{st} generation (1G) and 2^{nd} generation (2G) communication services, an online access platform using a smartphone was established in the 3^{rd} generation (3G) communication service, and today's fast wireless network is possible in the 4^{th} generation (4G) communication service. However, the 4G communication service has functional limitations in terms of ultra-low delay and super connection, and available frequency bands are also depleted.

The 5th generation (5G) communication service is expected to process data traffic of about 1000 times greater than 4G and have a speed of about 10 times faster than 4G and also expected to become a foundation of next-generation technologies such as virtual reality, augmented reality, autonomous driving, Internet of Things, etc. Accordingly, various communication equipment for millimeter wave (mmW)-based communication is under research.

### SUMMARY

The inventive concept provides a substrate integrated waveguide (SIW) including a glass substrate and an electromagnetic phased array (EPA) including the SIW.

Additional aspects will be set forth in part in the description which follows and, in part, will be apparent from the description, or may be learned by practice of the presented embodiments of the disclosure.

According to embodiments, an electromagnetic phased array (EPA) The EPA includes an signal distributor configured to divide an input signal and output first to fourth signals, first to fourth phase shifters configured to sequentially change phases of the first to fourth signals and output first to fourth phase shifted signals, and first to fourth antennas configured to sequentially generate electromagnetic waves on the basis of the first to fourth phase shifted signals, wherein the first phase shifter may include a first glass substrate and first and second waveguide side walls formed in the first glass substrate and defining a first waveguide that is a path of the first signal, the second phase shifter may include a second glass substrate and third and fourth waveguide side walls formed in the second glass substrate and defining a second waveguide that is a path of the second signal, the third phase shifter may include a third glass substrate and fifth and sixth waveguide side walls formed in the third glass substrate and defining a third waveguide that is a path of the third signal, the fourth phase shifter may include a fourth glass substrate and seventh and eighth waveguide side walls formed in the fourth glass substrate and defining a fourth waveguide that is a path of the fourth signal, and the first to fourth phase shifters are substrate integrated waveguides (SIW).

A thickness of each of the first glass substrate, the second glass substrate, the third glass substrate, and the fourth glass substrate may range from 0.1 mm to 0.6 mm.

A length of the second waveguide may be greater than a length of the first waveguide, a length of the third waveguide may be greater than a length of the second waveguide, and a length of the fourth waveguide may be greater than a length of the third waveguide

The first glass substrate, the second glass substrate, the third glass substrate, and the fourth glass substrate may be portions of the same glass substrate.

The first glass substrate, the second glass substrate, the third glass substrate, and the fourth glass substrate may be separate glass substrates that are separated from one another.

An average radius of curvature of the first waveguide may be less than an average radius of curvature of the second waveguide.

The EPA may further include a first switch device disposed between the first phase shifter and the signal distributor, and transmitting the first signal to the first phase shifter or blocking transmission of the first signal, a second switch device disposed between the second phase shifter and the signal distributor, and transmitting the second signal to the second phase shifter or blocking transmission of the second signal, a third switch device disposed between the third phase shifter and the signal distributor, and transmitting the third signal to the third phase shifter or blocking transmission of the third signal, and a fourth switch device disposed between the fourth phase shifter and the signal distributor, and transmitting the fourth signal to the fourth phase shifter or blocking transmission of the fourth signal.

The EPA may further include a first switch device disposed between the first phase shifter and a first antenna, and transmitting the first phase shifted signal to the first antenna or blocking transmission of the first phase shifted signal, a second switch device disposed between the second phase shifter and a second antenna, and transmitting the second phase shifted signal to the second antenna or blocking transmission of the second phase shifted signal, a third switch device disposed between the third phase shifter and a third antenna, and transmitting the third phase shifted signal to the third antenna or blocking transmission of the third phase shifted signal, and a fourth switch device disposed between the fourth phase shifter and a fourth antenna, and transmitting the fourth phase shifted signal to the fourth antenna or blocking transmission of the fourth phase shifted signal.

The first to eighth waveguide side walls each may be disposed and aligned in a first direction in which the first to fourth signals travel, and may include a plurality of conductive vias extending from upper surfaces to lower surfaces of the first glass substrate, the second glass substrate, the third glass substrate, and the fourth glass substrate.

The plurality of conductive vias included in the first and second side walls may be arranged in a line in the first direction.

The plurality of conductive vias included in the third and to eighth side walls may be arranged in zigzag in the first direction.

The signal distributor may be implemented by an SIW.

The signal distributor may be continuously formed with the first to fourth phase shifters.

According to other embodiments, a substrate integrated waveguide (SIW) The SIW includes a glass substrate, and first and second waveguide side walls defining a waveguide in the glass substrate, wherein the first and second waveguide side walls each are disposed and aligned in a first direction parallel to an upper surface of the glass substrate, and include a plurality of conductive vias extending from the upper surface to a lower surface of the glass substrate.

A plane shape of an upper surface of each of the conductive vias may be a circle, and a diameter of the circle may range from 30 μm to 200 μm.

A pitch of the conductive vias included in the first waveguide side walls may range from two times to eight times of the diameter.

Each of the conductive vias may include an upper conductive via having a tapered structure from the upper surface toward the lower surface of the glass substrate, and a lower conductive via having a tapered structure from the lower surface toward the upper surface of the glass substrate.

A second direction length of the upper conductive via perpendicular to the upper surface of the glass substrate may be the same as a second direction length of the lower conductive via.

A second direction length of the upper conductive via perpendicular to the upper surface of the glass substrate may be different from a second direction length of the lower conductive via.

According to other embodiments, an electromagnetic phased array (EPA) includes an signal distributor including an input port to which a signal is input and first to fourth output ports from which the signal is divided and output, first to fourth waveguides sequentially connected to the first to fourth output ports and having different lengths, and first to fourth antennas sequentially connected to the first to fourth waveguides, wherein the signal distributor and the first to fourth phase shifters include a substrate integrated waveguide (SIW) based on a glass substrate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A and FIG. 1B are block diagrams of an electromagnetic phased array (EPA) according to some embodiments;

FIG. 2A is a plan view of a phase shifter based on a substrate integrated waveguide (SIW) included in the EPA, according to some embodiments;

FIG. 2B is an enlarged plan view of a portion of FIG. 2A;

FIG. 2C is a cross-sectional view taken along line I-I′ of FIG. 2B;

FIGS. 3A to 3G are cross-sectional views of conductive vias included in an SWI-based phase shifter, according to other embodiments, each of the cross-sectional views corresponding to FIG. 2C;

FIG. 4A and FIG. 4B are plan views of an SIW-based phase shifter, according to other embodiments;

FIG. 5 is a plan view of a signal distributor that may be included in the EPA, according to some embodiments;

FIGS. 6A and 6B are plan views for explaining the effect of the SIW according to some embodiments; while FIG. 6C is a graph showing the effect of the SIW according to some embodiments;

FIG. 7A schematically illustrates the effect of a phase shifter according to some embodiments; and FIGS. 7B and 7C are graphs showing the effect of a phase shifter according to some embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the inventive concept are described below in detail with reference to the accompanying drawings. The embodiments of the inventive concept may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Like reference numerals in the drawings denote like elements, and thus their description will not be repeated. Furthermore, various elements and areas in the drawings are schematically drawn. Accordingly, the inventive concept is not limited by relative sizes or intervals drawn on the accompanying drawings.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the disclosure, a first constituent element may be referred to as a second constituent element, and vice versa.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. Furthermore, the terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

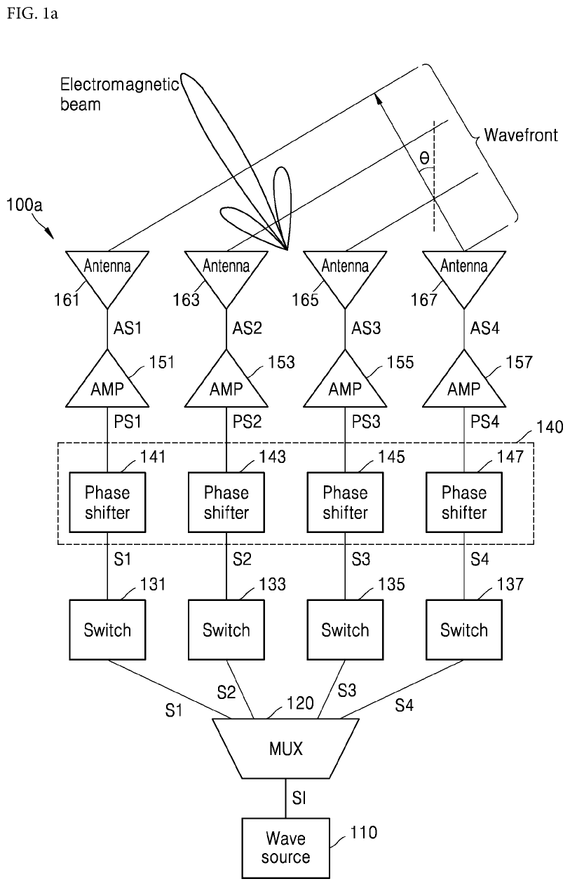

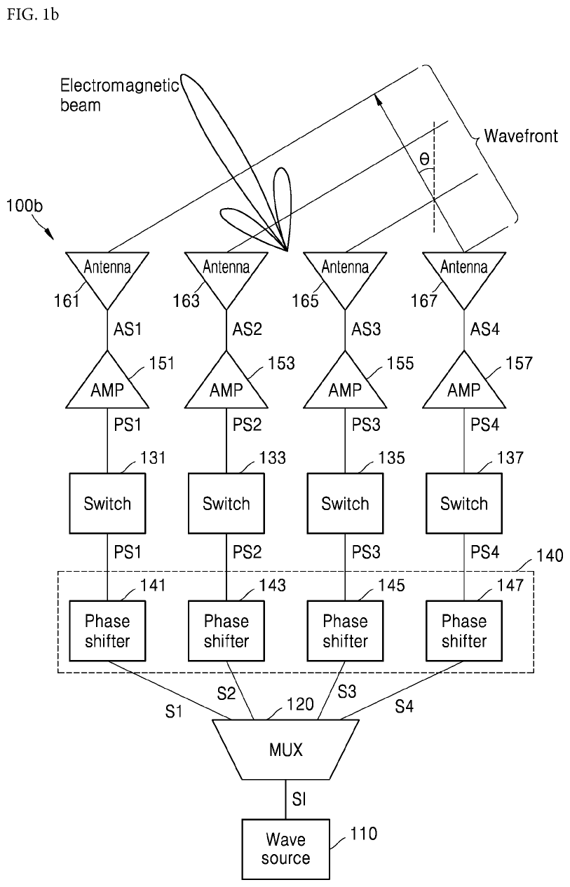

FIG. 1A is a block diagram of an electromagnetic phased array (EPA) 100a according to some embodiments.

Referring to FIG. 1A, the EPA 100a may include a wave source 110, a signal distributor 120, a first switch device 131, a second switch device 133, a third switch device 135, a fourth switch device 137, a substrate integrated waveguide (SIW)-based phase shifter 140, a first amplifier 151, a second amplifier 153, a third amplifier 155, a fourth amplifier 157, a first antenna 161, a second antenna 163 a third antenna 165, and a fourth antenna 167. In an example of FIG. 1A, the EPA 100a of 4 channels, which includes four phase shifters, that is, the first phase shifter 141, the second phase shifter 143, the third phase shifter 145, and the fourth phase shifter 147, and four antennas, that is, the first antenna 161, the second antenna 163, the third antenna 165, and the fourth antenna 167, is described, but this is merely exemplary and the technical concept of the inventive concept is not limited thereto. A person skilled in the art may easily implement an EPA having 5 or more channels such as an EPA having 8 channels, an EPA having 16 channels, or the like, on the basis of the descriptions herein.

The EPA 100a is a technology of irradiating an electromagnetic beam in a desired direction and pattern by applying signals having different phases to a plurality of arranged antennas, for example, the first antenna 161, the second antenna 163, the third antenna 165, and the fourth antenna 167. The EPA 100a may be widely used for radar, broadcast, astronomical observation, or the like, by using a radio frequency (RF) wave.

The wave source 110 may generate an electromagnetic wave of an RF band, for example, about 3 kHz to about 300 GHz. According to some embodiments, the wave source 110 may generate an electromagnetic wave having a frequency of about 3.5 GHz or more. According to some embodiments, the wave source 110 may generate an electromagnetic wave having a frequency of about 28 GHz or more. According to some embodiments, the wave source 110 may generate an electromagnetic wave having a frequency of about 79 GHz or more. According to some embodiments, as necessary, the wave source 110 may be a wavelength-tunable wave source which may change a wavelength of a generated electromagnetic wave to be within a set range. The wave source 110 may output an electromagnetic wave in the form of a pulse wave or continuous wave.

Referring to FIG. 1A, although the wave source 110 is included in the EPA 100a forming a single optical circuit, the disclosure is not limited thereto. When an EPA does not include a wave source, the wave source may be coupled to the EPA by a receiver or micro strip disposed outside the EPA.

The signal distributor 120 may be a branching device that equally divides an input signal SI into a plurality of signals and outputs divided signals. The signal distributor 120 may branch the input signal SI into a first signal S1, a second signal S2, a third signal S3, and a fourth signal S4 having substantially the same amplitude, but the disclosure is not limited thereto. For example, some of the first signal S1, the second signal S2, the third signal S3, and the fourth signal S4 may have different amplitudes.

According to some embodiments, the signal distributor 120 may include an SIW. According to some embodiments, the signal distributor 120 may be any one of a star coupler, a multi-mode interference, a Y branch splitter, and a directional coupler, each including an SIW including a glass substrate. According to some other embodiments, the signal distributor 120 may be formed based on an organic substrate such as a printed circuit board (PCB). The first signal S1 may be transmitted to the first switch device 131. The second signal S2 may be transmitted to the second switch device 133. The third signal S3 may be transmitted to the third switch device 135. The fourth signal S4 may be transmitted to the fourth switch device 137.

According to some embodiments, the signal distributor 120 included in the EPA 100a of 4 channels may include a single star coupler including four output ports, one multi-mode interference, or a single directional interference. According to some other embodiments, the signal distributor 120 included in the EPA 100a of 4 channels may include any one of a serial/parallel combination of a plurality of star couplers, a serial/parallel combination of a plurality of multi-mode interferences, a serial/parallel combination of a plurality of directional interferences, a serial/parallel combination of a plurality of Y branches, and a serial/parallel combination of a plurality of splitters. For example, the signal distributor 120 may have a full binary tree structure including signal branching devices having 1:2 signal distribution characteristics.

The first switch device 131 may transmit the first signal S1 in an on state and may block the first signal S1 in an off state. The second switch device 133 may transmit the second signal S2 in the on state and may block the second signal S2 in the off state. The third switch device 135 may transmit the third signal S3 in the on state and may block the third signal S3 in the off state. The fourth switch device 137 may transmit the fourth signal S4 in the on state and may block the fourth signal S4 in the off state.

The SIW-based phase shifter 140 may include the first phase shifter 141, the second phase shifter 143, the third phase shifter 145, and the fourth phase shifter 147. According to some embodiments, the first phase shifter 141, the second phase shifter 143, the third phase shifter 145, and the fourth phase shifter 147 may be a plurality of phase shifters formed on a single substrate. According to some other embodiments, the first phase shifter 141, the second phase shifter 143, the third phase shifter 145, and the fourth phase shifter 147 may be a plurality of phase shifters formed on different substrates.

The first phase shifter 141, the second phase shifter 143, the third phase shifter 145, and the fourth phase shifter 147 may be manual phase shifters. The first phase shifter 141 may change the phase of the first signal S1 to a set angle. The second phase shifter 143 may change the phase of the second signal S2 to a set angle. The third phase shifter 145 may change the phase of the third signal S3 to a set angle. The fourth phase shifter 147 may change the phase of the fourth signal S4 to a set angle. To change the phases of the first signal S1, the second signal S2, the third signal S3, and the fourth signal S4 may mean to change a phase difference between the first signal S1, the second signal S2, the third signal S3, and the fourth signal S4. The first phase shifter 141 may change the phase of the first signal S1 and output a first phase-shifted signal PS1. The second phase shifter 143 may change the phase of the second signal S2 and output a second phase-shifted signal PS2. The third phase shifter 145 may change the phase of the third signal S3 and output a third phase-shifted signal PS3. The fourth phase shifter 147 may change the phase of the fourth signal S4 and output a fourth phase-shifted signal PS4.

The first amplifier 151 may amplify the amplitudes of the first phase-shifted signals PS1 and output a first amplified signal AS1. The second amplifier 153 may amplify the amplitudes of the second phase-shifted signals PS2 and output a second amplified signal AS2. The third amplifier 155 may amplify the amplitudes of the third phase-shifted signals PS3 and output a third amplified signal AS3. The third amplifier 157 may amplify the amplitudes of the third phase-shifted signals PS4 and output a third amplified signal AS4. The phase difference of the first amplified signal AS1, the second amplified signal AS2, the third amplified signal AS3, and the fourth amplified signal and AS4 is substantially the same as the phase difference of the first phase-shifted signal PS1, the second phase-shifted signal PS2, the third phase-shifted signal PS3, and the fourth phase-shifted signal PS4.

In detail, the phase difference between the first phase-shifted signal PS1 and the second phase-shifted signal PS2 is the same as the phase difference between the first amplified signal AS1 and the second amplified signal AS2, the phase difference between the second phase-shifted signal PS2 and the third phase-shifted signal PS3 is the same as the phase difference between the second amplified signal AS2 and the third amplified signal AS3, and the phase difference between the third phase-shifted signal PS3 and the fourth phase-shifted signal PS4 is the same as the phase difference between the third amplified signal AS3 and the fourth amplified signal AS4.

The amplitudes of the first amplified signal AS1, the second amplified signal AS2, the third amplified signal AS3, and the fourth amplified signal and AS4 may be substantially the same. However, the disclosure is not limited thereto, and the amplitudes of the first amplified signal AS1, the second amplified signal AS2, the third amplified signal AS3, and the fourth amplified signal and AS4 may be different from one another.

The first antenna 161 may operate on the basis of the first amplified signal AS1, the second antenna 163 may operate on the basis of the second amplified signal AS2, the third antenna 165 may operate on the basis of the third amplified signal AS3 and the fourth antenna 167 may operate on the basis of the fourth amplified signal AS4. The first amplifier 151, the second amplifier 153, the third amplifier 155, and the fourth amplifier 157 may be omitted, and in this case, the first antenna 161 may operate on the basis of the first phase-shifted signal PS1, the second antenna 163 may operate on the basis of the second phase-shifted signal PS2, the third antenna 165 may operate on the basis of the third phase-shifted signal PS3 and the fourth antenna 167 may operate on the basis of the fourth phase-shifted signal PS4.

The first antenna 161, the second antenna 163, the third antenna 165, and the fourth antenna 167 may be any one of a patch antenna, a monopole antenna, a dipole antenna, and a parabolic antenna. The first antenna 161, the second antenna 163, the third antenna 165, and the fourth antenna 167 each may emit an electromagnetic wave of an RF band, for example, about 3 kHz to about 300 GHz. According to some embodiments, the first antenna 161, the second antenna 163, the third antenna 165, and the fourth antenna 167 may generate an electromagnetic wave having a wavelength of about 3.5 GHz or more. According to some embodiments, the first antenna 161, the second antenna 163, the third antenna 165, and the fourth antenna 167 may emit an electromagnetic wave having a wavelength of about 28 GHz or more. According to some embodiments, the first antenna 161, the second antenna 163, the third antenna 165, and the fourth antenna 167 may emit an electromagnetic wave having a wavelength of about 79 GHz or more.

The electromagnetic waves emitted by the first antenna 161, the second antenna 163, the third antenna 165, and the fourth antenna 167 may overlap one another forming an electromagnetic beam. FIG. 1A illustrates a wavefront of the electromagnetic wave emitted from each of the first antenna 161, the second antenna 163, the third antenna 165, and the fourth antenna 167, and the traveling direction of the wavefront may be substantially the same as the traveling direction of the electromagnetic beam. The traveling direction of the electromagnetic beam may mean the traveling direction of a main pole.

The electromagnetic wave generated by each of the first antenna 161, the second antenna 163, the third antenna 165, and the fourth antenna 167 may have substantially the same phase difference as the first phase-shifted signal PS1, the second phase-shifted signal PS2, the third phase-shifted signal PS3, and the fourth phase-shifted signal PS4. Accordingly, an orientation angle θ of the electromagnetic beam may depend on the phase difference of the first phase-shifted signal PS1, the second phase-shifted signal PS2, the third phase-shifted signal PS3, and the fourth phase-shifted signal PS4.

The first switch device 131, the second switch device 133, the third switch device 135, and the fourth switch device 137 and the first phase shifter 141, the second phase shifter 143, the third phase shifter 145, and the fourth phase shifter 147 together may adjust the orientation angle θ of the electromagnetic beam output from the first antenna 161, the second antenna 163, the third antenna 165, and the fourth antenna 167.

For example, when the first switch device 131 is turned off and the second switch device 133, the third switch device 135, and fourth switch device 137 are turned on, the electromagnetic beam may be formed through the overlapping of the electromagnetic waves emitted by the second antenna 163, the third antenna 165, and the fourth antenna 167 and the orientation angle θ of the electromagnetic beam may be a first angle. Likewise, when the second switch device 133 only is turned off, the orientation angle θ of the electromagnetic beam may be a second angle different from the first angle, when the third switch device 135 only is turned off, the orientation angle θ of the electromagnetic beam may be a third angle different from the first angle and the second angle, and when the fourth switch device 137 only is turned off, the orientation angle θ of the electromagnetic beam may be a fourth angle different from the first to third angles.

FIG. 1B is a block diagram of an EPA 100b according to other embodiments.

For convenience of explanation, redundant descriptions to those of FIG. 1A are omitted and only differences therebetween are mainly described.

Referring to FIG. 1B, the EPA 100b may include the wave source 110, the signal distributor 120, the first switch device 131, the second switch device 133, the third switch device 135, the fourth switch device 137, the SIW-based phase shifter 140, the first amplifier 151, the second amplifier 153, the third amplifier 155, the fourth amplifier 157, the first antenna 161, the second antenna 163, the third antenna 165, and the fourth antenna 167.

FIG. 1B, unlike FIG. 1A, the first signal S1, the second signal S2, the third signal S3, and the fourth signal S4 distributed by the signal distributor 120 may be input to the SIW-based phase shifter 140. In this case, as the signal distributor 120 and the SIW-based phase shifter 140 are disposed close to each other, the signal distributor 120 and the SIW-based phase shifter 140 may be simultaneously formed based on a single glass substrate. Accordingly, the manufacturing costs of the EPA 100b may be reduced and a production speed thereof may be improved.

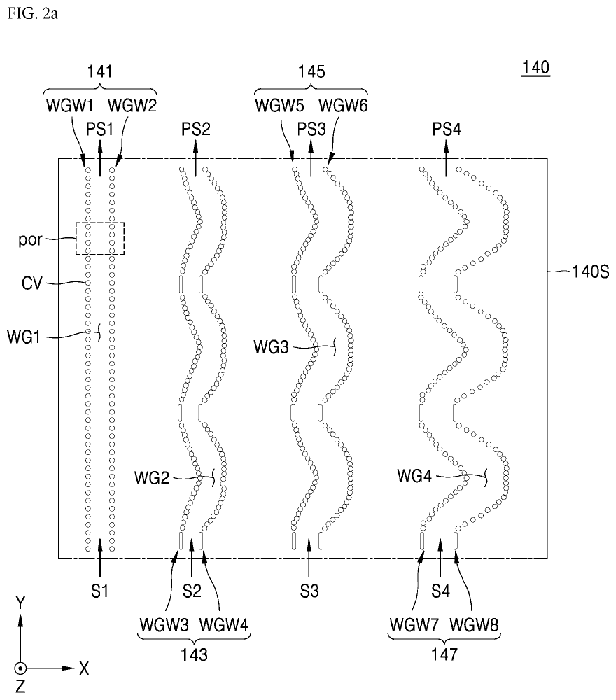

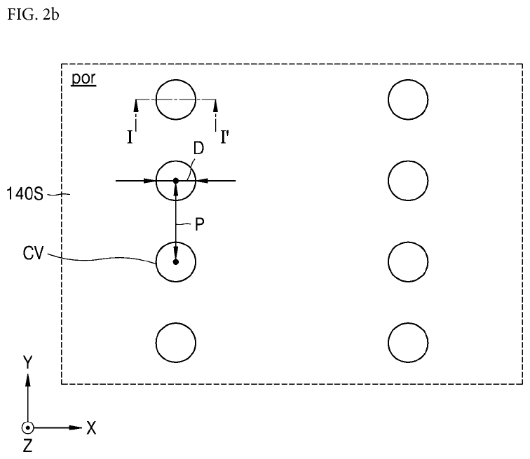

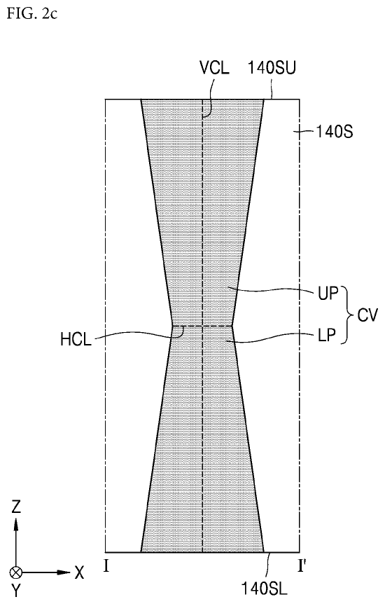

FIG. 2A is a plan view of the SIW-based phase shifter 140 included in the EPA, according to some embodiments.

FIG. 2B is an enlarged plan view of a portion “por” of FIG. 2A.

FIG. 2C is a cross-sectional view taken along line I-I′ of FIG. 2B.

Referring to FIGS. 2A to 2C, the SIW-based phase shifter 140 may include the first phase shifter 141, the second phase shifter 143, the third phase shifter 145, and the fourth phase shifter 147 that are formed on a glass substrate 140S. The first phase shifter 141, the second phase shifter 143, the third phase shifter 145, and the fourth phase shifter 147 may be SIWs having paths of different lengths.

The glass substrate 140S may include alkali-free glass, but the disclosure is not limited thereto. For example, the glass substrate 140S may include soda glass. When the glass substrate 140S includes alkali-free glass, permittivity and a dielectric loss factor may be low.

According to some embodiments, although the glass substrate 140S may have a thickness, that is, a length in the Z direction, of about 0.1 mm to about 0.6 mm, the disclosure is not limited thereto. In the SIW-based phase shifter 140 for 28 GHz band communication, a glass substrate 140S having a thickness of about 0.3 mm to about 0.6 mm may be used, and in the SIW-based phase shifter 140 for 77 GHz band communication, a glass substrate 140S having a thickness of about 0.1 mm to about 0.3 mm may be used.

Directions parallel to an upper surface 140SU of the glass substrate 140S and perpendicular to each other are defined to be an X direction and a Y direction, respectively. A direction perpendicular to the upper surface 140SU of the glass substrate 140S is defined to be a Z direction. Unless otherwise specified, the definitions of the directions are substantially the same in other drawings. In an example of FIG. 2A, the first signal S1, the second signal S2, the third signal S3, and the fourth signal S4 may travel substantially in the Y direction.

The first phase shifter 141 may include a first waveguide side wall WGW1 and a second waveguide side wall WGW2 defining a waveguide and a first part of the glass substrate 140S provided between the first waveguide side wall WGW1 and the second waveguide side wall WGW2 and functioning as a waveguide. The second phase shifter 143 may include a third waveguide side wall WGW3 and a fourth waveguide side wall WGW4 defining a waveguide and a second part of the glass substrate 140S provided between the third waveguide side wall WGW3 and the fourth waveguide side wall WGW4 and functioning as a waveguide. The third phase shifter 145 may include a fifth waveguide side wall WGW5 and a sixth waveguide side wall WGW6 defining a waveguide and a third part of the glass substrate 140S provided between the fifth waveguide side wall WGW5 and the sixth waveguide side wall WGW6 and functioning as a waveguide. The fourth phase shifter 147 may include a seventh waveguide side wall WGW7 and a eighth waveguide side wall WGW8 defining a waveguide and a fourth part of the glass substrate 140S provided between the seventh waveguide side wall WGW7 and the eighth waveguide side wall WGW8 and functioning as a waveguide.

The first waveguide side wall WGW1 and the second waveguide side wall WGW2 may define a first waveguide WG1 having a linear shape and extending in the Y direction, and being a path through which the first signal S1 travels. The third waveguide side wall WGW3 and the fourth waveguide side wall WGW4 may define a second waveguide WG2 extending in the Y direction, bending in zigzag, and being a path through which the second signal S2 travels. The fifth waveguide side wall WGW5 and the sixth waveguide side wall WGW6 may define a third waveguide WG3 extending in the Y direction, bending in zigzag, and being a path through which the third signal S4 travels. The seventh waveguide side walls WGW7 and the eighth waveguide side wall WGW8 may define a fourth waveguide WG4 extending in the Y direction, bending in zigzag, and being a path through which the fourth signal S4 travels.

According to some embodiments, an average radius of curvature of the first waveguide WG1 may be less than an average radius of curvature of the second waveguide WG2, an average radius of curvature of the second waveguide WG2 may be less than an average radius of curvature of the third waveguide WG3, and an average radius of curvature of the third waveguide WG3 may be less than an average radius of curvature of the fourth waveguide WG4.

Accordingly, in the SIW-based phase shifter 140, the length of the second waveguide WG2 that is a path of the second signal S2 may be longer than the length of the first waveguide WG1 that is a path of the first signal S1, the length of the third waveguide WG3 that is a path of the third signal S3 may be longer than the length of the second waveguide WG2 that is a path of the second signal S2, and the length of the fourth waveguide WG4 that is a path of the fourth signal S4 may be longer than the length of the third waveguide WG3 that is a path of the third signal S3. Although FIG. 2A illustrates the first phase shifter 141, the second phase shifter 143, the third phase shifter 145, and the fourth phase shifter 147 in an increasing order of the length of a waveguide, this is merely exemplary, and the technical concept of the inventive concept is not limited thereto.

Each of the first to eighth waveguide side walls WGW1, WGW2, WGW3, WGW4, WGW5, WGW6, WGW7, WGW8 may include a plurality of conductive vias CV horizontally spaced apart from each other.

An upper surface of each of the conductive vias CV may be approximately circular. According to some embodiments, a diameter D of the upper surface of each of the conductive vias CV may be in a range of about 30 μm to about 200 μm. According to some embodiments, the diameter D may be about 100 μm.

A pitch P between the conductive vias CV that neighbor with each other and are included in any one of the first to eighth waveguide side walls WGW1, WGW2, WGW3, WGW4, WGW5, WGW6, WGW7, WGW8 may be in a range of about 2 times to about 8 times of the diameter D. According to some embodiments, the pitch P may be about 200 μm.

According to some embodiments, the conductive vias CV may be rotationally symmetrical to a vertical center line VCL. According to some embodiments, each of the conductive vias CV may include an upper conductive via UP and a lower conductive via LP. The upper conductive via UP and the lower conductive via LP each may have a tapered structure toward a horizontal center line HCL of the glass substrate 140S. The tapered structure toward the horizontal center line HCL may mean a structure having a horizontal width, for example, a diameter, that decreases toward the horizontal center line HCL. The upper conductive via UP and the lower conductive via LP of each of the conductive vias CV each may have the least width at the horizontal center line HCL. The width of the upper conductive via UP of each of the conductive vias CV may gradually increase toward the upper surface 140SU in the Z direction. The width of the lower conductive via UP of each of the conductive vias CV may gradually increase toward a lower surface 140SL in the Z direction.

Each of the conductive vias CV may be formed by depositing a conductive material by a chemical vapor deposition (CVD) method in a hole formed by performing a laser drilling process on the upper surface 140SU and the lower surface 140SL of the glass substrate 140S. Accordingly, each of the conductive vias CV may have the above-described structure.

Although FIG. 2C illustrates that the upper conductive via UP and the lower conductive via LP of each of the conductive vias CV have an integrally continuous structure, the disclosure is not limited thereto. In an example, the upper conductive via UP of each of the conductive vias CV may include the same material as the lower conductive via LP and may have a discontinuous structure having a boundary surface. In another example, the upper conductive via UP of each of the conductive vias CV may include a material different from the lower conductive via LP.

According to some embodiments, the SIW-based phase shifter 140 implemented on the glass substrate 140S may be provided. When the SIW-based phase shifter 140 is implemented on the glass substrate 140S through a laser drilling process, vias, each having a diameter less than that of the SIW using an existing PCB, may be formed at a higher density, that is, at a less pitch. Accordingly, the path of each of the first phase shifter 141, the second phase shifter 143, the third phase shifter 145, and the fourth phase shifter 147 including the SIW implemented on the glass substrate 140S may be designed relatively freely, and may have a relatively low attenuation rate of a degree similar to that of a waveguide implemented of a metal material.

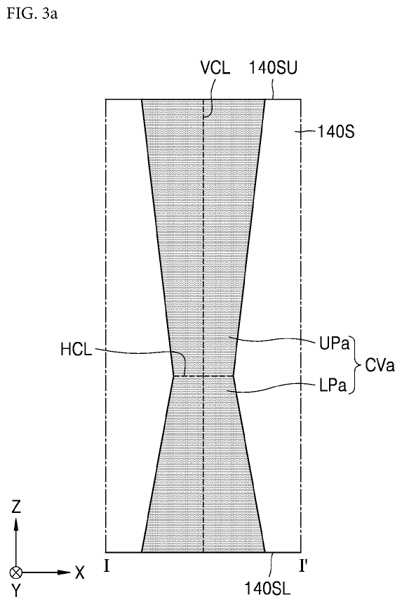

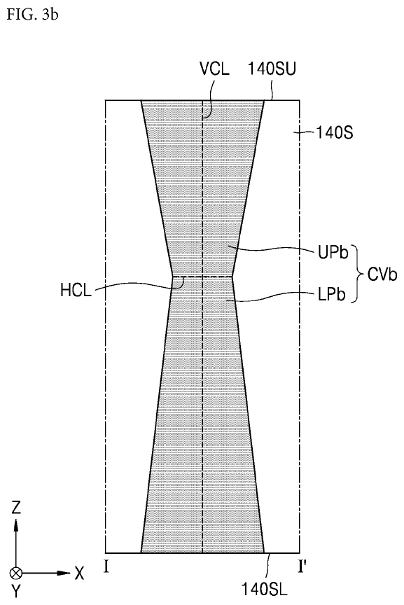

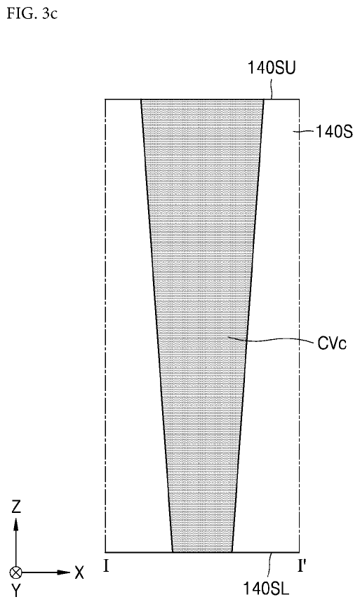

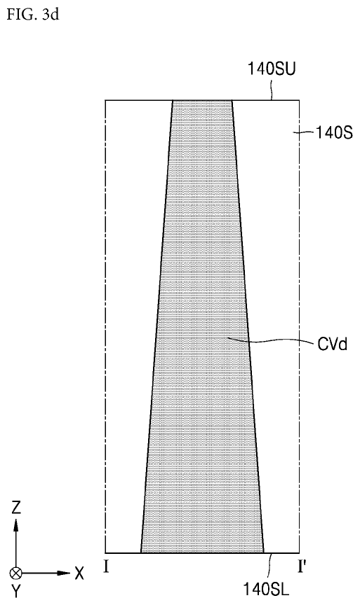

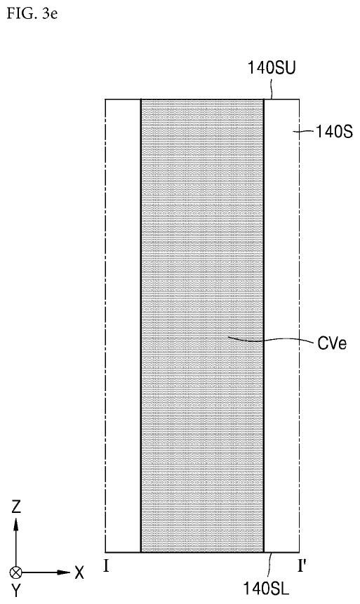

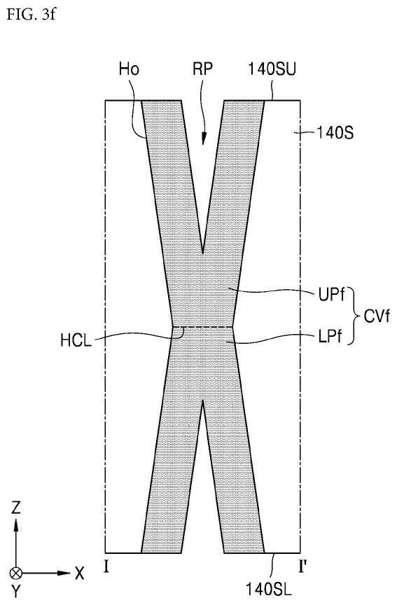

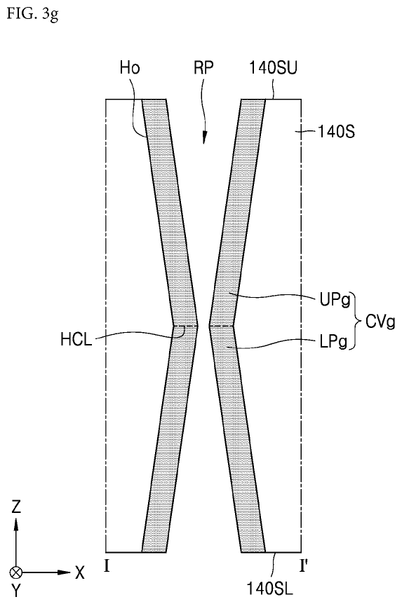

FIGS. 3A to 3G are cross-sectional views of conductive vias CVa, CVb, CVc, CVd, CVe, CVf, and CVg included in an SIW-based phase shifter, according to other embodiments, each of the cross-sectional views corresponding to FIG. 2C.

Referring to FIG. 3A, each of the conductive vias CVa may have a structure similar to the conductive vias CV of FIG. 2C, in which the length of an upper conductive via UPa in the Z direction may be longer than the length of a lower conductive via LPa in the Z direction.

Referring to FIG. 3B, each of the conductive vias CVb may have a structure similar to the conductive vias CV of FIG. 2C, in which the length of a lower conductive via LPb in the Z direction may be longer than the length of an upper conductive via UPb in the Z direction.

Referring to FIG. 3C, each of the conductive vias CVc may have a tapered structure toward the lower surface 140SL from the upper surface 140SU of the glass substrate 140S. Accordingly, the width of each of the conductive vias CVc may be the greatest at the same level as the upper surface 140SU, and the width of each of the conductive vias CVc may be the least at the same level as the lower surface 140SL. The width of the first part of each of the conductive vias CVc may be greater than the width of the second part under the first part.

Referring to FIG. 3D, each of the conductive vias CVd may have a tapered structure toward the upper surface 140SU from the lower surface 140SL of the glass substrate 140S. Accordingly, the width of each of the conductive vias CVd may be the greatest at the same level as the lower surface 140SL, and the width of each of the conductive vias CVd may be the least at the same level as the upper surface 140SU. The width of the first part of each of the conductive vias CVd may be greater than the width of the second part above the first part.

Referring to FIG. 3E, each of the conductive vias CVe may have substantially the same width in the Z direction. Accordingly, the conductive vias CVe may have an approximately cylindrical shape.

Referring to FIG. 3F, each of the conductive vias CVf may not completely fill holes Ho formed in the glass substrate 140S. Accordingly, a recess portion RP defined to be a cone-shaped space may be formed in each of an upper surface of an upper conductive via UPf and a lower surface of a lower conductive via LPf.

Referring to FIG. 3G, each of the conductive vias CVg may be formed to be conformal in the holes Ho formed in the glass substrate 140S. Each of the conductive vias CVg may comprise an upper conductive via LPa and a lower conductive via LPb. Accordingly, each of the conductive vias CVg may have a penetration portion PR therein while covering a side wall of the holes Ho formed in the glass substrate 140S.

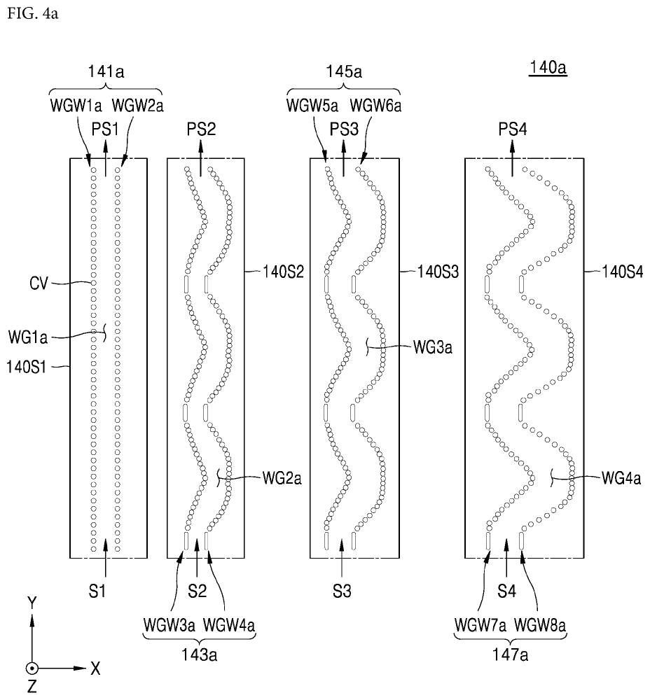

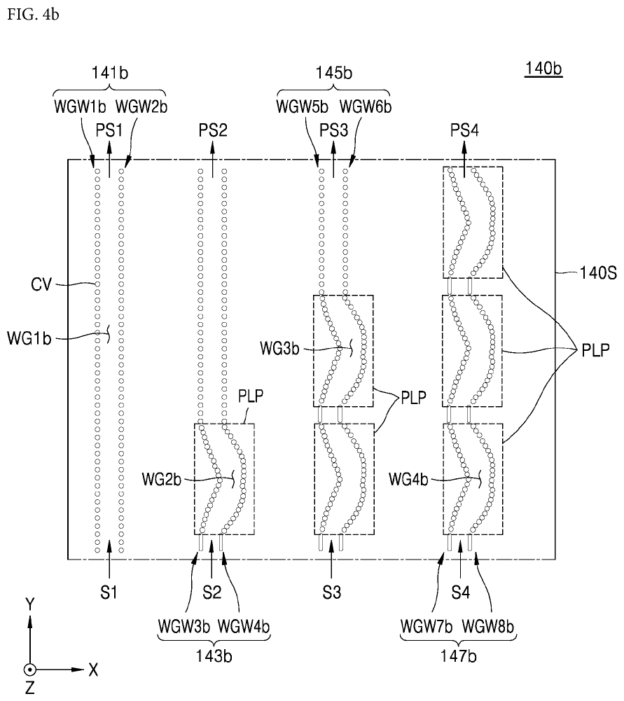

FIG. 4A is a plan view of an SIW-based phase shifter 140a according to other embodiments.

For convenience of explanation, redundant descriptions to those of FIGS. 2A to 2D are omitted and only differences therebetween are mainly described.

Referring to FIG. 4A, the SIW-based phase shifter 140a may include a first phase shifter 141a, a second phase shifter 143a, a third phase shifter 145a, and a fourth phase shifter 147a. The first phase shifter 141a, the second phase shifter 143a, the third phase shifter 145a, and the fourth phase shifter 147a may be similar to the first phase shifter 141, the second phase shifter 143, the third phase shifter 145, and the fourth phase shifter 147 of FIG. 2A. The first phase shifter 141a may be formed on a first glass substrate 140S1, the second phase shifter 143a may be formed on a second glass substrate 140S2, the third phase shifter 145a may be formed on a third glass substrate 140S3, and the fourth phase shifter 147a may be formed on a fourth glass substrate 140S4. The first glass substrate 140S1, the second glass substrate 140S2, the second glass substrate 140S3 and the third glass substrate 140S4 are separate glass substrates.

In detail, the first phase shifter 141a may include first and second waveguide side walls WGW1a and WGW2a formed on the first glass substrate 140S1, the second phase shifter 143a may include third and fourth waveguide side walls WGW3a and WGW4A formed on the second glass substrate 140S2, the third phase shifter 145a may include fifth and sixth waveguide side walls WGW5a and WGW6a formed on the third glass substrate 140S3, and the fourth phase shifter 147a may include seventh and eighth waveguide side walls WGW7a and WGW8a formed on the fourth glass substrate 140S4.

The first and second waveguide side walls WGW1a and WGW2a may define a first waveguide WG1a, the third and fourth waveguide side walls WGW3a and WGW4A may define a second waveguide WG2a, the fifth and sixth waveguide side walls WGW5a and WGW6a may define a third waveguide WG3a, and the seventh and eighth waveguide side walls WGW7a and WGW8a may define a fourth waveguide WG4a.

The path length between the first to fourth waveguides WG1a to WG4a and a phase relation of the first to fourth phase-shifted signals PS1 to PS4 according thereto are similar to the phase relation between the first to fourth waveguides WG1 to WG4 of FIG. 2A.

FIG. 4B is a plan view of an SIW-based phase shifter 140b according to other embodiments.

For convenience of explanation, redundant descriptions to those of FIGS. 2A to 2D are omitted and only differences therebetween are mainly described.

Referring to FIG. 4B, the SIW-based phase shifter 140b may include first to fourth phase shifters 141b, 143b, 145b, and 147b.

The first phase shifter 141b may include first and second waveguide side walls WGW1b and WGW2b that define a first waveguide WG1b on the glass substrate 140S provided therebetween. The second phase shifter 143b may include third and fourth waveguide side walls WGW3b and WGW4B that define a second waveguide WG2b on the glass substrate 140S provided therebetween. The third phase shifter 145b may include fifth and sixth waveguide side walls WGW5b and WGW6b that define a third waveguide WG3b on the glass substrate 140S provided therebetween. The fourth phase shifter 147b may include seventh and eighth waveguide side walls WGW7b and WGW8b that define a fourth waveguide WG4B on the glass substrate 140S provided therebetween.

According to some embodiments, the first to eighth waveguide side walls WGW1b to WGW8b may include the conductive vias CV.

According to some embodiments, some of the first to fourth phase shifters 141b, 143b, 145b, and 147b may include a phase delay portion PLP that is a curve path. The phase delay portion PLP defines a curved waveguide, and the phase of a signal traveling along the phase delay portion PLP may be delayed compared to a signal traveling along a linear waveguide.

According to some embodiments, the first to fourth phase shifters 141b, 143b, 145b, and 147b each may include a different number of phase delay portions PLP. Accordingly, a phase difference between the first phase-shifted signal PS1, the second phase-shifted signal PS2, the third phase-shifted signal PS3, and the fourth phase-shifted signal PS4 output by the first to fourth phase shifters 141b, 143b, 145b, and 147b may have a set value.

In an example of FIG. 4B, the second phase shifter 143b may include one more phase delay portion PLP than the first phase shifter 141b includes, the third phase shifter 145b may include one more phase delay portion PLP than the second phase shifter 143b includes, and the fourth phase shifter 147b may include one more phase delay portion PLP than the third phase shifter 145b.

According to some embodiments, phase delay angles of a plurality of phase delay portions PLP included in the first to fourth phase shifters 141b, 143b, 145b, and 147b may be substantially the same. For example, a first phase difference between the first and second phase-shifted signals PS1 and PS2 output by the first and second phase shifters 141b and 143b, a second phase difference between the second and third phase-shifted signals PS2 and PS3 output by the second and third phase shifters 143b and 145b, and a third phase difference between the third and fourth phase-shifted signals PS3 and PS4 output by the third and fourth phase shifters 145b and 147b may be the same.

In an example, when a phase delay according to one phase delay portion PLP is 135° and the phase of the first phase-shifted signal PS1 output by the first phase shifter 141b is 0° that is a reference phase, the phase of the second phase-shifted signal PS2 output by the second phase shifter 143b may be 135°, the phase of the third phase-shifted signal PS3 output by the third phase shifter 145b may be 270°, and the phase of the fourth phase-shifted signal PS4 output by the fourth phase shifter 147b may be 405°.

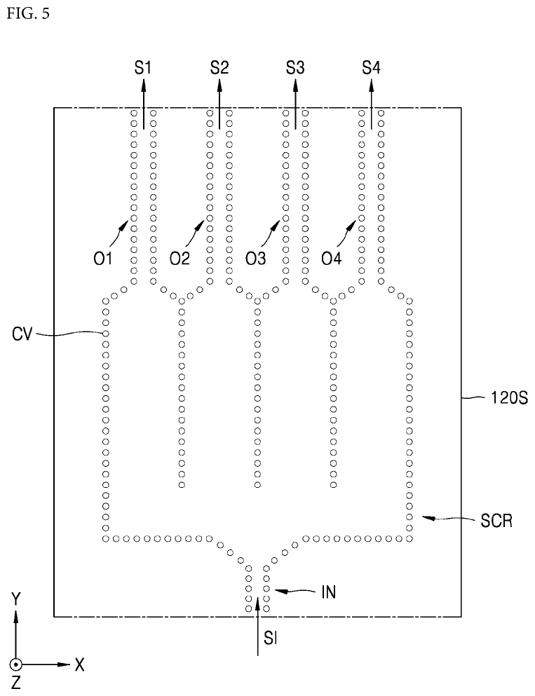

FIG. 5 is a plan view of the signal distributor 120 that may be included in the EPA 100a (see FIG. 1A), according to some embodiments.

Referring to FIG. 5, the signal distributor 120 may include an input port IN, an SIW coupling region SCR, and first to fourth output ports O1, O2, O3, and O4, which are formed on a glass substrate 120S.

Similar to the illustrations of FIGS. 2A to 2C, the conductive vias CV may define the input port IN, the SIW coupling region SCR, and the first to fourth output ports O1, O2, O3, and O4. The conductive vias CV may have any one of sectional structures of FIGS. 2C to 3G.

An input signal SI input to the input port IN may be divided in the SIW coupling region SCR into the first signal S1, the second signal S2, the third signal S3, and the fourth signal S4 and sequentially output to the first to fourth output ports O1, O2, O3, and O4.

According to some embodiments, the glass substrate 120S may be a glass substrate that is separate from the glass substrate 140S of FIG. 2A. According to some other embodiments, the glass substrate 120S may be a part of the same glass substrate as the glass substrate 140S of FIG. 2A.

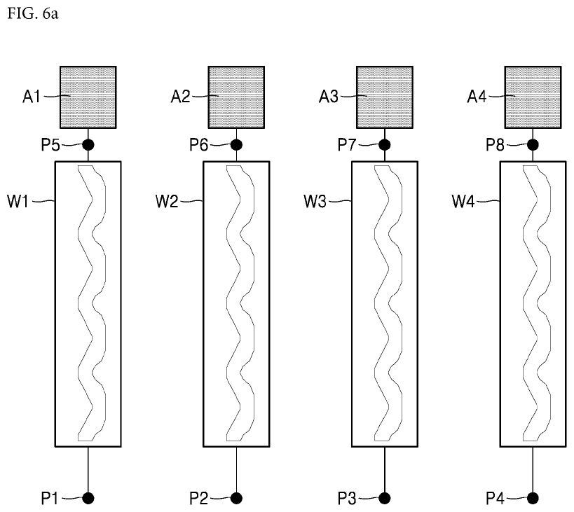

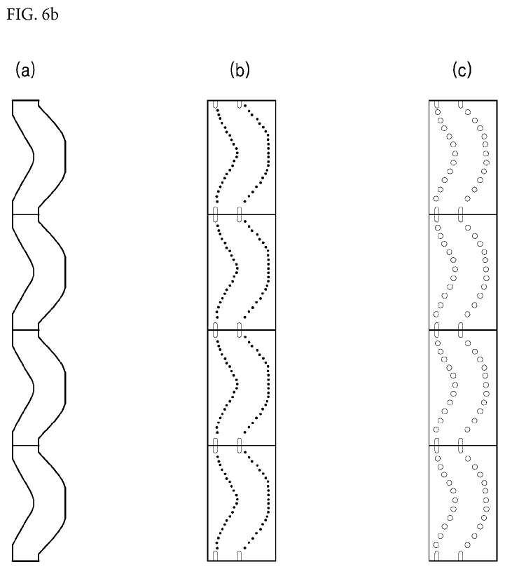

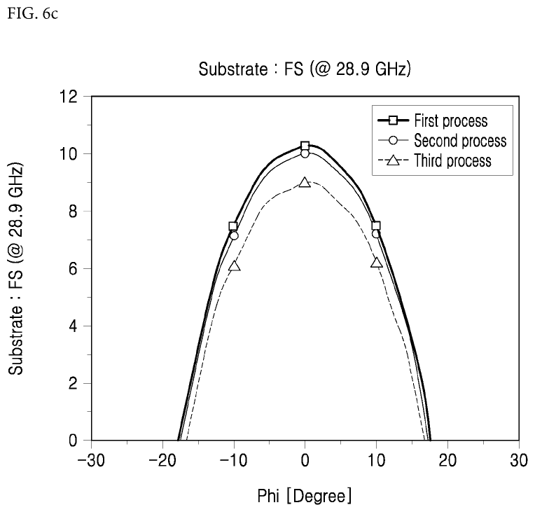

FIGS. 6A and 6B are plan views for explaining the effect of the SIW according to some embodiments.

In detail, FIGS. 6A and 6B are plan views of the set-up of an experiment for explaining the effect of the SIW according to some embodiments, and FIG. 6C is a graph showing the result of the experiment.

Referring to FIG. 6A, the EPA may include first to fourth waveguides W1, W2, W3, and W4 formed to have the same phase delay and first to fourth antennas A1, A2, A3, and A4 sequentially connected to the first to fourth waveguides W1, W2, W3, and W4.

An input port of the first waveguide W1 is a first port P1, and an output port thereof is a fifth port P5. The first antenna A1 may be connected to the fifth port P5. An input port of the second waveguide W2 is the second port P2, and an output port thereof is the sixth port P6. The second antenna A2 may be connected to the sixth port P6. An input port of the third waveguide W3 is the third port P3, and an output port thereof is the seventh port P7. The third antenna A3 may be connected to the seventh port P7. An input of the fourth waveguide W4 is the fourth port P4, and an output port thereof is the eighth port P8. The second antenna A2 may be connected to the eighth port P8.

Tables 1 and 2 below show insertion loss, that is, an attenuation rate of a signal between an input port and an output port, when forming a waveguide i) on any one of a fused silica material substrate, a TMM-4 material substrate, and a flame retardant (FR)-4 material substrate, ii) in any one process of first to third processes below, and iii) inputting a signal having any one frequency of 28 GHz, 28.9 GHZ, 79 GHZ, and 81 GHz to an input port. The first to fourth waveguides W1, W2, W3, and W4 have the same shape, and Tables 1 to 4 show only insertion loss of the first waveguide.

The first process is a process of forming a perfect electric conductor (PEC) side wall as illustrated in a portion (a) of FIG. 6B, the second process is a laser drilling process of forming an SIW including conductive vias as illustrated in a portion (b) of FIG. 6B, and the third process is a mechanical drilling process of forming an SIW including conductive vias as illustrated in a portion (c) of FIG. 6B.

In Table 1, the respective waveguides are designed to have the same phase delay. In Table 2, the respective waveguides are designed to have the same shape.

TABLE 1

| | | | | |
|---|---|---|---|---|
| Signal | Waveguide | Fused | | |
| Frequency | Forming Process | Silica | TMM-4 | FR-4 |

| | | | | | |
|---|---|---|---|---|---|
| 28 | GHz | First Process | 0.08 | 0.96 | 12.15 |
| | | Second Process | 0.63 | 1.5 | 12.64 |
| | | Third Process | 0.74 | 1.67 | 12.89 |
| 28.9 | GHz | First Process | 1.95 | 2.7 | 12.99 |
| | | Second Process | 2.56 | 3.31 | 13.64 |
| | | Third Process | 4.81 | 5.44 | 14.54 |
| 79 | GHz | First Process | 0.09 | 0.95 | 12.41 |
| | | Second Process | 0.43 | 1.32 | 12.5 |
| | | Third Process | 0.55 | 1.46 | 12.88 |
| 81 | GHz | First Process | 0.1 | 1.02 | 12.5 |
| | | Second Process | 0.48 | 1.35 | 12.5 |
| | | Third Process | 2.3 | 3.09 | 13.4 |

TABLE 2

| | | | | |
|---|---|---|---|---|
| Signal | Waveguide | Fused | | |
| Frequency | Forming Process | Silica | TMM-4 | Fr-4 |

| | | | | | |
|---|---|---|---|---|---|
| 28 | GHz | First Process | 0.09 | 0.96 | 12 |
| | | Second Process | 0.63 | 1.5 | 12.64 |
| | | Third Process | 0.61 | 1.49 | 12.69 |
| 28.9 | GHz | First Process | 1.61 | 2.41 | 12.88 |
| | | Second Process | 2.56 | 3.31 | 13.46 |
| | | Third Process | 4.53 | 5.22 | 14.65 |
| 79 | GHz | First Process | 0.11 | 0.98 | 12.24 |
| | | Second Process | 0.43 | 1.32 | 12.5 |
| | | Third Process | 0.52 | 1.39 | 12.56 |
| 81 | GHz | First Process | 0.09 | 1.02 | 12.27 |
| | | Second Process | 0.48 | 0.35 | 12.55 |
| | | Third Process | 1.12 | 1.97 | 12.83 |

Tables 3 and 4 below show gain of the first antenna A1 when forming a waveguide i) on any one of a fused silica material substrate, a TMM-4 material substrate, and an FR-4 material substrate, ii) in any one process of the first to third processes, and iii) inputting a signal having any one frequency of 28 GHZ, 28.9 GHZ, 79 GHz, and 81 GHz to an input port.

In Table 3, the respective waveguides are designed to have the same phase delay. In Table 4, the respective waveguides are designed to have the same shape.

TABLE 3

| | | | | |
|---|---|---|---|---|
| Signal | Waveguide | Fused | | |
| Frequency | Forming Process | Silica | TMM-4 | Fr-4 |

| | | | | | |
|---|---|---|---|---|---|
| 28 | GHz | First Process | 10.75 | 10.56 | 4.8 |
| | | Second Process | 10.64 | 10.43 | 4.42 |
| | | Third Process | 10.61 | 10.39 | 4.22 |
| 28.9 | GHz | First Process | 10.31 | 10.09 | 4.14 |
| | | Second Process | 10.14 | 9.9 | 3.75 |
| | | Third Process | 9.32 | 9.05 | 2.85 |
| 79 | GHz | First Process | 11.98 | 11.82 | 6.67 |
| | | Second Process | 11.92 | 11.75 | 6.6 |
| | | Third Process | 11.9 | 11.72 | 6.35 |
| 81 | GHz | First Process | 11.97 | 11.83 | 6.6 |
| | | Second Process | 11.91 | 11.74 | 6.58 |
| | | Third Process | 11.52 | 11.31 | 6 |

TABLE 4

| | | | | |
|---|---|---|---|---|
| Signal | Waveguide | Fused | | |
| Frequency | Forming Process | Silica | TMM-4 | Fr-4 |

| | | | | | |
|---|---|---|---|---|---|
| 28 | GHz | First Process | 10.75 | 10.56 | 4.9 |
| | | Second Process | 10.64 | 10.43 | 4.42 |
| | | Third Process | 10.64 | 10.44 | 4.37 |
| 28.9 | GHz | First Process | 10.42 | 10.18 | 4.22 |
| | | Second Process | 10.14 | 9.9 | 3.75 |
| | | Third process | 9.44 | 9.14 | 2.76 |
| 79 | GHz | First Process | 11.97 | 11.82 | 6.78 |
| | | Second Process | 11.92 | 11.75 | 6.6 |
| | | Third Process | 11.9 | 11.73 | 6.57 |
| 81 | GHz | First Process | 11.97 | 11.81 | 6.77 |
| | | Second Process | 11.91 | 11.74 | 6.58 |
| | | Third Process | 11.79 | 11.6 | 6.38 |

Referring to Tables 1 to 4, it is confirmed that a waveguide of the first experiment example based on fused silica with respect to a signal having a frequency of 28 GHz or more, in particular, 79 GHZ, has a lower attenuation rate than a waveguide configured of a PCB such as the second comparative example, and has a low attenuation rate of a level similar to the first comparative example that is configured with PEC. In particular, it is confirmed that, at a frequency of 79 GHz or more, a waveguide based on a glass substrate has an attenuation rate that is much improved compared with the PCB-based waveguide.

According to some embodiments, as the SIW-based phase shifter formed on the glass substrate by using laser drilling is provided, the reliability of the phase shifter and the EPA including the phase shifter may be improved.

FIG. 6C is a graph showing the effect of the SIW according to some embodiments.

Referring to FIG. 6C, a magnitude-orientation angle graph of a main pole portion of a radiation pattern of an electromagnetic beam when a 28.9 GHZ signal is input to the EPAs of FIG. 6A formed by using the first to third processes. Referring to FIG. 6C, it is confirmed that the radiation pattern of the EPA according to the second process has an equal level to the radiation pattern of the EPA according to the first process to form the PEC.

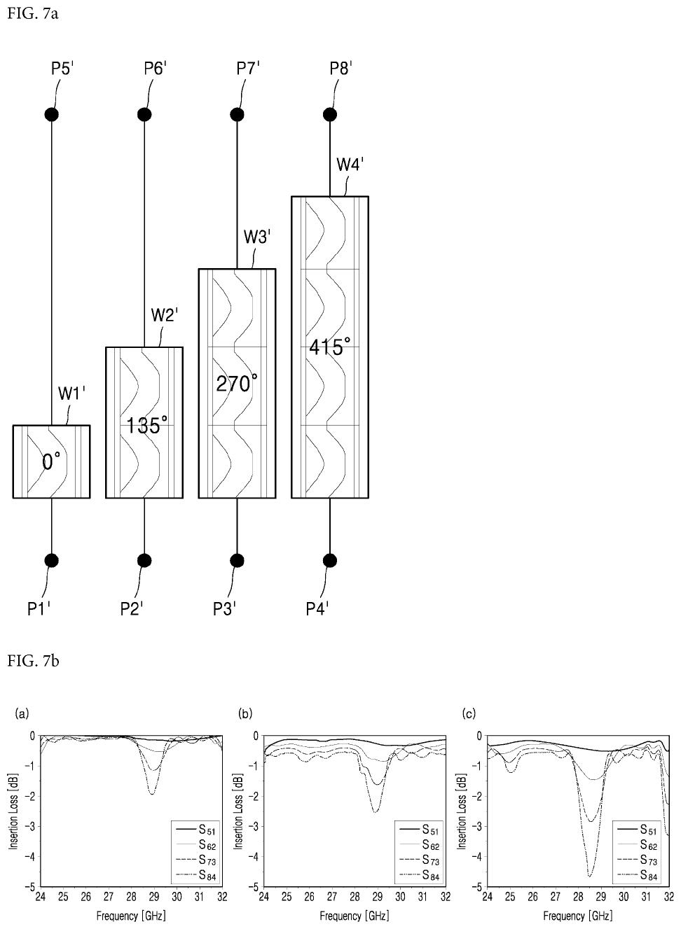

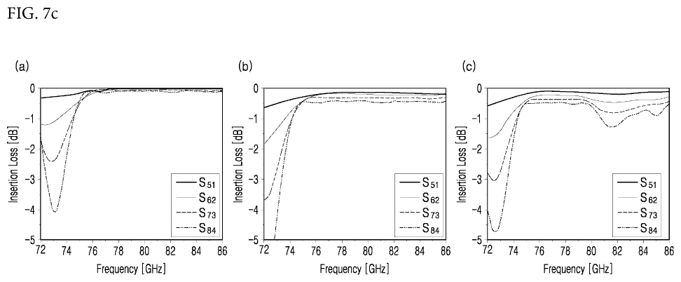

FIG. 7A schematically illustrates the effect of a phase shifter according to some embodiments, and FIGS. 7B and 7C are graphs showing the effect of a phase shifter according to some embodiments.

The phase shifter of FIG. 7A may include first to fourth waveguides W1′, W2′, W3′, and W4′. In an experiment example of FIG. 7A, when a phase delay of the first waveguide W1′ is 0°, phase delays of the second to fourth waveguides W2′, W3′, and W4′ are sequentially 135°, 270°, and 405°.

An input port of the first waveguide W1′ is a first port P1′, and an output port thereof is a fifth port P5′. An input port of the second waveguide W2′ is a second port P2′, and an output port thereof is a sixth port P6′. An input port of the third waveguide W3′ is a third port P3′, and an output port thereof is a seventh port P7′. An input port of the fourth waveguide W4′ is a fourth port P4′, and an output port thereof is an eighth port P8′.

Referring to FIGS. 7A and 7B, insertion losses S51, S62, S73 and S84 according to the frequencies of the phase shifters configured as illustrated in FIG. 7A are illustrated. In an experiment example of FIG. 7B, a center frequency of each phase shifter is designed to be 28 GHz.

The insertion loss S51 indicates insertion loss between the first and fifth ports P1′ and P5′, that is, insertion loss of the first waveguide W1′. The insertion loss S62 indicates insertion loss between the second and sixth ports P2′ and P6′, that is, insertion loss of the second waveguide W2′. The insertion loss S73 indicates insertion loss between the third and seventh ports P3′ and P7′, that is, insertion loss of the third waveguide W3′. The insertion loss S84 indicates insertion loss between the fourth and eighth ports P4′ and P8′, that is, insertion loss of the fourth waveguide W8′.

In detail, a portion (a) of FIG. 7B indicates insertion loss of the phase shifter of FIG. 7A configured as the PEC waveguide as illustrated in the portion (a) of FIG. 6B, a portion (b) of FIG. 7B indicates insertion loss of the phase shifter of FIG. 7A configured as the SIW-based on a glass substrate as illustrated in the portion (b) of FIG. 6B, and a portion (c) of FIG. 7B indicates insertion loss of the phase shifter of FIG. 7A configured as the SIW-based on an organic substrate including a material such as TMM-4, FR-4, or the like, as in the portion (c) of FIG. 6B.

For the respective cases, it is confirmed that, while the insertion loss S51 is the least, the insertion loss S84 is the most, which is due to a path difference between the waveguides. Furthermore, it is confirmed that a difference between the insertion losses S51 and S84 of the phase shifter including a glass substrate-based SIW is at a level similar to that of the phase shifter including PEC waveguides, and much lower than the phase shifter including an organic substrate-based SIW.

In FIG. 7B, it is confirmed that the phase shifter including a glass substrate-based SIW according to some embodiments has superior gain characteristics in a 5G mmW band.

Referring to FIG. 7C, the insertion losses S51, S62, S73 and S84 according to the frequencies of the phase shifters configured as illustrated in FIG. 7A are illustrated. In an experiment example of FIG. 7C, the center frequency of each phase shifter is designed to be 79 GHz.

A portion (a) of FIG. 7C indicates insertion loss of the phase shifter of FIG. 7A including PEC waveguides as illustrated in the portion (a) of FIG. 6B, a portion (b) of FIG. 7C indicates insertion loss of the phase shifter of FIG. 7A including a glass substrate-based SIW as illustrated in the portion (b) of FIG. 6B, and a portion (c) of FIG. 7C indicates insertion loss of the phase shifter of FIG. 7A including an organic substrate-based SIW including a material such as TMM-4, FR-4, or the like, as illustrated in the portion (c) of FIG. 6B.

As illustrated in FIG. 7C, it is confirmed that, while the phase shifter configured as the glass substrate-based SIW has a flat gain curve similar to the phase shifter including PEC waveguides in a frequency band around 79 GHz that is the center frequency, the phase shifter including an organic substrate-based SIW has a slightly irregular gain curve in a frequency band around 79 GHz that is the center frequency. In FIG. 7C, it is confirmed that the phase shifter including a glass substrate-based SIW according to some embodiments has superior gain characteristics in a super high frequency band, for example, around 79 GHZ, which may be used for the next-generation communication technology such as sixth generation (6G).

According to the inventive concept, an SIW including a glass substrate and an EPA including the SIW may be provided. Accordingly, an SIW having improved signal attenuation characteristics and design freedom compared with the existing organic substrate-based SIW, and an EPA including the SIW, may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An electromagnetic phased array (EPA) comprising:
an signal distributor configured to divide an input signal into a plurality of output signals, the plurality of output signal comprising a first signal, a second signal, a third signal and a fourth signal;
a first phase shifter configured to change a phase of the first signal and output a first phase shifted signal;
a second phase shifter configured to change a phase of the second signal and output a second phase shifted signal;
a third phase shifter configured to change a phase of the third signal and output a third phase shifted signal;
a fourth phase shifter configured to change a phase of the fourth signal and output a fourth phase shifted signal;
a first antenna configured to generate electromagnetic waves on the basis of the first phase shifted signal;
a second antenna configured to generate electromagnetic waves on the basis of the second phase shifted signal
a third antenna configured to generate electromagnetic waves on the basis of the third phase shifted signal
a fourth antenna configured to generate electromagnetic waves on the basis of the fourth phase shifted signal
wherein the first phase shifter comprises a first glass substrate and first and second waveguide side walls formed in the first glass substrate and defining a first waveguide that is a path of the first signal,
the second phase shifter comprises a second glass substrate and third and fourth waveguide side walls formed in the second glass substrate and defining a second waveguide that is a path of the second signal,
the third phase shifter comprises a third glass substrate and fifth and sixth waveguide side walls formed in the third glass substrate and defining a third waveguide that is a path of the third signal,
the fourth phase shifter comprises a fourth glass substrate and seventh and eighth waveguide side walls formed in the fourth glass substrate and defining a fourth waveguide that is a path of the fourth signal, and
wherein the first phase shifter, the second phase shifter, the third phase shifter, and the fourth phase shifter are substrate integrated waveguides (SIW).

2. The EPA of claim 1, wherein a thickness of each of the first glass substrate, the second glass substrate, the third glass substrate, and the fourth glass substrate ranges from 0.1 mm to 0.6 mm.

3. The EPA of claim 1, wherein a length of the second waveguide is greater than a length of the first waveguide, a length of the third waveguide is greater than a length of the second waveguide, and a length of the fourth waveguide is greater than a length of the third waveguide

4. The EPA of claim 1, wherein each of the first glass substrate, the second glass substrate, the third glass substrate, and the fourth glass substrate are portions of the same glass substrate.

5. The EPA of claim 1, wherein the first glass substrate, the second glass substrate, the third glass substrate, and the fourth glass substrate are separate glass substrates that are separated from one another.

6. The EPA of claim 1, wherein an average radius of curvature of the first waveguide is less than an average radius of curvature of the second waveguide.

7. The EPA of claim 1, further comprising:
a first switch device disposed between the first phase shifter and the signal distributor, and transmitting the first signal to the first phase shifter or blocking transmission of the first signal;
a second switch device disposed between the second phase shifter and the signal distributor, and transmitting the second signal to the second phase shifter or blocking transmission of the second signal;
a third switch device disposed between the third phase shifter and the signal distributor, and transmitting the third signal to the third phase shifter or blocking transmission of the third signal; and
a fourth switch device disposed between the fourth phase shifter and the signal distributor, and transmitting the fourth signal to the fourth phase shifter or blocking transmission of the fourth signal.

8. The EPA of claim 1, further comprising:
a first switch device disposed between the first phase shifter and the first antenna, and transmitting the first phase shifted signal to the first antenna or blocking transmission of the first phase shifted signal;
a second switch device disposed between the second phase shifter and the second antenna, and transmitting the second phase shifted signal to the second antenna or blocking transmission of the second phase shifted signal;
a third switch device disposed between the third phase shifter and the third antenna, and transmitting the third phase shifted signal to the third antenna or blocking transmission of the third phase shifted signal; and
a fourth switch device disposed between the fourth phase shifter and the fourth antenna, and transmitting the fourth phase shifted signal to the fourth antenna or blocking transmission of the fourth phase shifted signal.

9. The EPA of claim 1, wherein each of the first waveguide side wall, the second waveguide side wall, the third waveguide side wall, the fourth waveguide side wall, the fifth waveguide side wall, the sixth waveguide side wall, the seventh waveguide side wall, and the eighth waveguide side wall is disposed and aligned in a first direction in which the first to fourth signals travel, and comprise a plurality of conductive vias extending from upper surfaces to lower surfaces of the first glass substrate, the second glass substrate, the third glass substrate, and the fourth glass substrate.

10. The EPA of claim 9, wherein the plurality of conductive vias included in the first waveguide side wall and second waveguide side wall are arranged in a line in the first direction.

11. The EPA of claim 9, wherein the plurality of conductive vias included in the third waveguide side wall, the fourth waveguide side wall, the fifth waveguide side wall, the sixth waveguide side wall, the seventh waveguide side wall, and the eighth side wall are arranged in zigzag in the first direction.

12. The EPA of claim 1, wherein the signal distributor is implemented by an SIW.

13. The EPA of claim 12, wherein the signal distributor is continuously formed with the first to fourth phase shifters.

14. A substrate integrated waveguide (SIW) comprising:
a glass substrate; and
first waveguide side wall and second waveguide side wall each defining a waveguide in the glass substrate,
wherein each of the first waveguide side wall and the second waveguide side wall is disposed and aligned in a first direction parallel to an upper surface of the glass substrate, and comprise a plurality of conductive vias extending from the upper surface to a lower surface of the glass substrate, and
wherein each of conductive vias include conductive material.

15. The SIW of claim 14, wherein a plane shape of an upper surface of each of the conductive vias is a circle, and a diameter of the circle of the upper surface of each of the conductive vias ranges from 30 μm to 200 μm.

16. The SIW of claim 15, wherein a pitch of the conductive vias included in the first waveguide side wall ranges from two times to eight times of the diameter.

17. The SIW of claim 14, wherein each of the conductive vias comprises:
an upper conductive via having a tapered structure from the upper surface toward the lower surface of the glass substrate; and
a lower conductive via having a tapered structure from the lower surface toward the upper surface of the glass substrate.

18. The SIW of claim 17, wherein a second direction length of the upper conductive via perpendicular to the upper surface of the glass substrate is the same as a second direction length of the lower conductive via.

19. The SIW of claim 17, wherein a second direction length of the upper conductive via perpendicular to the upper surface of the glass substrate is different from a second direction length of the lower conductive via.

20. An electromagnetic phased array (EPA) comprising:
an signal distributor comprising an input port, a first output port, a second output port, a third output port, and a fourth output port;
a first waveguide connected to the first output port, a second waveguide connected to the second output port, a third waveguide connected to the third output port, and a fourth waveguide connected to the fourth output port, the first waveguide, the second waveguide, the third waveguide and the fourth wave guide having different lengths; and
a first antennas connected to the first waveguide, a second antennas connected to the second waveguide, a third antennas connected to the third waveguide, a fourth antennas connected to the fourth waveguide,
wherein each of the signal distributor, the first waveguide, the second waveguide, the third waveguide, and the fourth waveguide comprise a substrate integrated waveguide (SIW) based on a glass substrate.
